(19) United States
(12) Patent Application Publication
(10) Pub. No.: US 2015/0291432 A1
(43) Pub. Date: Oct. 15, 2015

(54) PRODUCTION OF ACTIVATED CARBON FROM TOBACCO LEAVES BY SIMULTANEOUS CARBONIZATION AND SELF-ACTIVATION AND THE ACTIVATED CARBON THUS OBTAINED

(71) Applicant: POLITECHNIKA POZNANSKA, Poznan (PL)

(72) Inventors: Francois Béguin, Poznan (PL); Elzbieta Frackowiak, Poznan (PL); Piotr Kleszyk, Zabkowice Slaskie (PL)

(21) Appl. No.: 14/443,101

(22) PCT Filed: Nov. 16, 2013
(86) PCT No.: PCT/PL2013/050030

§ 371 Date: May 15, 2015

(30) Foreign Application Priority Data
Nov. 16, 2012 (PL) P.401640
Nov. 16, 2012 (PL) P.401641

(51) Int. Cl. C01B 31/12; H01G 11/34; C01B 31/08; H01G 11/42; H01G 11/38; H01G 11/52; H01G 11/36

(52) U.S. Cl. CPC C01B 31/12; H01G 11/52; H01G 11/34; H01G 11/36; H01G 11/42; H01G 11/38; C01B 31/083; C01B 31/08; C01P 2006/90; C01P 2006/40; C01P 2006/12; C01P 2006/16; C01P 2006/14

(57) ABSTRACT

The invention relates to a method for manufacturing activated carbon from tobacco leaves by simultaneous carbonization and self-activation in an inert gas environment. The activated carbon produced by this new method has a specific surface area from 600 to 2000 m² g⁻¹, preferably 1700 m² g⁻¹, and has an extensive amount of ultramicropores and mesopores, wherein the ratio of the micropore volume to the mesopore volume is at minimum of 3:1, up to 10:1, preferably 4:1. The average pore size (L₀) is in the range of 0.55-1.3 nm, preferably 0.8-1.2 nm, with a total pore volume of 0.2 to 1.25 cm³ g⁻¹. The invention also refers to an electrode comprising the activated carbon having the above properties as well as the electrochemical capacitor with such an electrode.

The invention relates to the production of activated carbon from tobacco leaves (Nicotiana) by simultaneous carbonization and self-activation, the activated carbon thus produced and the carbon electrode prepared from the self-activated carbon. The invention also provides an electrochemical capacitor comprising at least one electrode made of the activated carbon produced from tobacco precursor by simultaneous carbonization and self-activation.

### TECHNICAL FIELD

The term “activated carbon” (also called active carbon) refers to a group of amorphous carbons, manufactured on the basis of carbon-containing precursors, which have a high degree of porosity and developed specific surface area. These parameters are obtained by pyrolysis of different carbon-containing substances, and then activation by using chemical or physical processes. The activated carbon is obtained in the form of granules, powder, fibrous material, cloth or monoliths. Activated carbons are produced from various organic precursors: polymers, peat, coal, fruit seeds, nut shells, wood, etc.

The main criteria for selecting an activated carbon for a given application are its surface chemical composition and porous texture (pore volume, specific surface area, pore size distribution). The pore texture can be divided into three types: the micropores of diameter less than 2 nm, mesopores having a diameter of 2 nm to 50 nm and macropores having a diameter greater than 50 nm. The micropores of diameter less than 0.7-0.8 nm are called ultramicropores.

All carbonaceous materials can be converted into activated carbon, however, the process requires the use of an external activating agent. The properties of the final product vary depending on the nature of the raw material used, the nature of the activating agent and the conditions of the activation process.

The traditional production of activated carbon involves two basic steps: first, carbonization of the precursor having in its structure elemental carbon, at a temperature below 800° C. under oxygen-free atmosphere, and a second step of activation of the previously carbonized product.

During the second step, the pores of the previously carbonized material are opened and new pores are created.

Depending on the precursor and activation conditions, the activated carbons may have different porous texture and different surface functional groups, both responsible for different physico-chemical properties.

In general, the known activation processes can be grouped into two main types: chemical activation and physical activation. In the chemical activation process with phosphoric acid, the activation of the raw precursor is carried out after its impregnation with the acid. For other chemical activation agents such as potassium hydroxide, the chemical agent is mixed with the pre-carbonized precursor which is thus chemically activated. Physical activation of the carbonized precursor is generally carried out in the presence of suitable oxidizing gases such as steam, carbon dioxide, air or a mixture of these gases.

However, a new type recently discovered, called self-activation, could be included into the activation methodologies similarly; its operation depends on the selection of an appropriate raw material. In the self-activation, the carbonization and activation processes of the raw material take place simultaneously and autogenously, so the second phase of chemical or physical activation is needless. The ability to carry out the self-activation process depends, however, on the chemical composition of the precursor (plant material, extracts from plants and substances including elements that might take an active part in the activation process), and the type of substances generated during the carbonization. The compounds determining the ability of the precursor for self-activation are usually derivatives of groups I and II elements of the periodic chart, e.g., Li, Na, K, Rb, Cs, Mg, Ca, Ba, Sr—naturally present at the atomic level, for example as sodium alginate occurring in seaweeds, built in the structure of the embedded material.

Activated carbon is widely used, i.a. in gas molecular separation, purification of drinking water, waste water and air, pollutant sorption, sorption of chemicals, for hydrogen and methane storage, as a carrier for catalysts or as a standalone catalyst. It is used in de-colorization, for removing odors, removing chemicals and detoxification of drinking water. Activated carbon is also used for solvent recovery, air purification in residential areas, in the food and chemical industry, in the purification of many chemical products and the purification of gases. It is also used in hydrometallurgy as for example in recovery of gold and silver. In addition, it is used in human medicine for bacterial culture media, for detoxification in poisoning, purification of blood, as absorber of toxic substances.

Activated carbon is also an excellent electrode material for energy storage in electrochemical capacitors. Electrochemical capacitors are named as well electrical double-layer capacitors, supercapacitors or ultracapacitors. Electrochemical capacitor electrodes are usually made of a composite of two or three materials, i.e., porous activated carbon powder and a binder, and optionally a filler with good electrical conductivity, designed to increase the conductivity of the electrodes.

An electrochemical capacitor is made of two electrodes immersed in an electrolyte, separated by a porous separator, permeable to ions. The system is protected from the external environment by an especially designed container. The use of porous activated carbon for the electrodes of the supercapacitor results in an increase of the electrode surface area, and provides a substantially larger capacitance. The obtaining of a higher capacitance is also favored by an appropriate pore size distribution of the carbon electrode material. The pore size of activated carbons should be adapted to the diameter of the electrolyte ions, so it is important to optimize their size for any particular electrolyte. The specific surface area of activated carbons that make up the electrodes generally ranges from 600 to 2000 m² g⁻¹.

Electrochemical capacitors provide a higher energy density than dielectric capacitors and higher power density than batteries. They are particularly useful for applications which require pulses of energy in short periods of time, such as seconds or minutes. They can be used for energy storage and delivery in cars, buses, rail vehicles, emergency doors and evacuation slides in airplanes, UPS, transformer stations, cranes, elevators, wind farms and solar farms etc.

### BACKGROUND ART

The known methods for producing activated carbon from tobacco use oven and/or microwave reactor. Such processes are described in patent applications: CN101508434 and CN101508435, which describe the method of physical activation of pre-carbonized tobacco stems.

Application CN1669917 presents the activation method of tobacco waste with steam in a microwave reactor.

Application CN1669918 presents the process of activation of tobacco stems with potassium hydroxide in a microwave reactor.

Application CN1669919 illustrates the activation of tobacco stems first with phosphorus acid, followed by potassium hydroxide in a microwave reactor.

Application CN101407323 discloses a method for the activation of tobacco stems with potassium hydroxide in an oven.

Application CN1821071 refers to the description of an apparatus and process used to activate tobacco stalks. However, no information is provided about the activation process itself.

Application CN1362359 presents a method for the activation of tobacco wastes with zinc chloride in a microwave reactor.

Application CN103121682 describes a method of impregnation of ground tobacco stems with an activation agent, and then their activation in an oven.

Application CN102992321 describes a method of impregnation of ground tobacco stems with organic acid solutions, followed by their activation in an oven.

Application CN102311113 describes a method for the manufacture of electrodes for supercapacitors, made of activated carbons produced from tobacco stems. The activated carbons are prepared by impregnating the tobacco stems with an alkali carbonate solution and then carbonization.

Furthermore, the activated carbons produced from tobacco in two-step process (carbonization followed by physical or chemical activation) are described in the publications:

H. Xia, J. Peng, L. Zhang, X. Tu, X. Ma, J. Tu, “Study on the preparation of granular activated carbon from tobacco stems activation by steam”, Lizi Jiaohuan Yu Xifu/Ion Exchange and Adsorption, 23 (2007) 112-118, which describes a process for the activation of tobacco waste with steam;

L. Yang, H. Yi, X. Tang, Q. Yu, Z. Ye, H. Deng, Effect of carbonization temperature on the textural and phosphine adsorption properties of activated carbon from tobacco stems, Fresenius Environmental Bulletin, 20 (2011) 405-410, wherein a process of tobacco waste activation with potassium hydroxide in a microwave reactor is disclosed;

L. B. Zhang, J. H. Peng, N. Li, H. Y. Xia, W. Li, W. W. Qu, X. Y. Zhu, “Carbonization process in preparation of activated carbon from tobacco stems with KOH-activation”, Huaxue Gongcheng/Chemical Engineering (China), 37 (2009) 59-62, which discloses a process of tobacco waste activation with potassium hydroxide in an oven, whereas the publication L. B. Zhang, J. H. Peng, H. Y. Xia, N. Li, W. Li, W. W. Qu, X. Y. Zhu, “Research on preparation of high specific surface area activated carbon from tobacco stem by microwave heating”, Wuhan Ligong Daxue Xuebao, Journal of Wuhan University of Technology, 30 (2008) 76-79, provides a process of tobacco waste activation with potassium hydroxide in a microwave reactor.

The publication L. B. Zhang, J. H. Peng, H. Y. Xia, W. Li, W. W. Qu, X. Y. Zhu, “Preparation of high specific surface area activated carbon from tobacco stem with potassium carbonate activation by microwave heating”, Gongneng Cailiao, Journal of Functional Materials, 39 (2008) 136-138, presents a process of tobacco stems activation with potassium carbonate in a microwave reactor.

All these documents reveal the production of activated carbon from tobacco, generally in two high-temperature, energy consuming, non-environmental friendly steps.

In addition, the publication X. Xia, H. Liu, L. Shi, Y. He, “Tobacco Stem-Based Activated Carbons for High Performance Supercapacitors”, Journal of Materials Engineering and Performance, (2011) 1-6, describes an example of activation of tobacco wastes with potassium hydroxide in a microwave reactor.

The use of activated carbon from tobacco in supercapacitors is described in the following publications:

Patent application CN102311113 describes a method for the manufacture of electrodes for supercapacitors with activated carbons produced from tobacco stalks. In addition, the mentioned publication X. Xia, H. Liu, L. Shi, Y. He, “Tobacco Stem-Based Activated Carbons for High Performance Supercapacitors”, Journal of Materials Engineering and Performance (2011) 1-6, describes the use of tobacco active carbon, activated with potassium hydroxide in a microwave reactor, in an electrochemical capacitor.

The self-activation process is described in the patent application US2009052117 A1 wherein self-activation of seaweed as a plant substrate is disclosed.

In addition, the following scientific publications describe the production of self-activated carbons from seaweeds or seaweed biopolymer and their application in supercapacitors: E. Raymundo-Piñero, F. Leroux, and, F. Béguin, “A High-Performance Carbon for Supercapacitors Obtained by Carbonization of a Seaweed Biopolymer” Adv. Mater., 18 (2006) 1877-1882

E. Raymundo-Piñero, M. Cadek, and F. Béguin, “Tuning Carbon Materials for Supercapacitors by Direct Pyrolysis of Seaweeds”, Adv. Funct. Mater., 19 (2009) 1-8M. P. Bichat, E. Raymundo-Piñero, F. Béguin, “High voltage supercapacitor built with seaweed carbons in neutral aqueous electrolyte”, Carbon, 48 (2010) 4351-4361.

The object of the invention is to provide a simple, ecological, non-expensive method for producing activated carbons of very good performance characteristics from tobacco leaves, by the self-activation process.

### SUMMARY OF INVENTION

The subject of the invention is a method for producing activated carbon from tobacco, wherein the tobacco plant is dried to completely evaporate water, and then the resultant dry mass is subjected to simultaneous carbonization and self-activation by heating at a temperature of 550-1000° C., preferably 750-850° C., under anaerobic conditions in an atmosphere of an inert gas. The inorganic residue present in the resulting carbon is dissolved, and the carbon is further washed with water until the filtrate reaches a constant pH close to 7, and then dried to completely evaporate the water.

Preferably, the tobacco plant is dried to completely evaporate water at a temperature in the range 80-200° C., preferably 105-115° C., the resultant dry mass is preferably grinded to a uniform powder, and then the process of simultaneous carbonization and self-activation is carried out preferably with a flow of nitrogen as an inert gas, for at least 15 min, preferably at least 60 min, after which the inorganic residue present in the resulting carbon is dissolved by an inorganic base followed by an inorganic acid or preferably is dissolved by at least one inorganic acid. Preferably, the inorganic residue present in the resulting carbon is dissolved by sodium hydroxide followed by hydrochloric acid or preferably is dissolved by hydrofluoric acid and/or hydrochloric acid.

In another preferred embodiment, the tobacco dry mass, before simultaneous carbonization and self-activation, is pre-treated by heating at a temperature of 400-520° C. in an inert atmosphere to evaporate the oily fraction.

In another preferred embodiment of the process, the resultant activated carbon (purified and dried) is further subjected to a thermal post-treatment under neutral atmosphere at a temperature of 700-1000° C., preferably 800-900° C. for at least 15 minutes, to eliminate surface functionalities and provoke a structural/textural reorganization which permits a conductivity enhancement. This is particularly beneficial for the application of thus activated carbon for supercapacitor electrodes.

The plant material subject to the process of simultaneous carbonization with self-activation is preferably tobacco leafs blade and/or tobacco midrib of the leaf (main vain), hereinafter called leafs stem or simply stem.

The subject of the invention is also the activated carbon produced by simultaneous carbonization and self-activation of tobacco leaves as described above, having a specific surface area from 600 to 2000 m² g⁻¹, preferably 1700 m² g⁻¹, and an extensive amount of ultramicropores and mesopores, with the ratio of mesopores volume to the micropores volume of at least 3:1, up to 10:1, preferably 4:1, and the average pore size (L₀) in the range of 0.55-1.3 nm, preferably 0.8-1.2 nm, and the total pore volume of 0.2 to 1.25 cm³ g⁻¹.

The activated carbon obtained in the above process can be used for gas molecular separation, pollutant sorption, sorption of chemicals, for hydrogen and methane storage, as a carrier for catalysts and as a standalone catalyst, for the purification of gases, air, water and solvents, as well as electrode material.

The invention also comprises a carbon electrode made of a composite having as a main component the activated carbon produced from tobacco by simultaneous carbonization and self-activation described above.

The carbon electrode is made of a composite comprising at least 65% by weight, preferably 85% by weight of the activated carbon having a surface area from 600 to 2000 m² g⁻¹, preferably 1700 m² g⁻¹, wherein the average pore size (L₀) is in the range of 0.55-1.3 nm, preferably 0.8-1.2 nm, and the total pore volume in the range from 0.2 to 1.25 cm³ g⁻¹, wherein the ratio of the micropores volume to the mesopores volume is at least 3:1, up to 10:1, preferably 4:1, mixed with a polymeric binder in the amount up to 25% by weight, preferably 5 to 10% by weight relative to the weight of the electrode.

Optionally, the composite comprises additionally carbon black or graphene or carbon nanotubes in the amount of up to 10% by weight of the electrode, preferably 5% by weight.

The polymeric binder in the electrode can be selected from polyvinylidene fluoride, polytetrafluoroethylene, carboxymethyl cellulose, sodium alginate and cellulose.

The invention refers also to an electrochemical capacitor comprising at least one electrode made of activated carbon, separated from the other electrode by a porous separator, located in a chamber filled with an electrolyte, wherein the electrode is made of a composite having as the main component the activated carbon produced from tobacco leaf in the process of simultaneous carbonization and self-activation. In the capacitor, the electrode is preferably made of 65% by weight, more preferably 85% by weight of the activated carbon, mixed with a polymeric binder in the amount of up to 25%, preferably 5-10% by weight relative to the weight of the electrode.

The solution according to the invention provides for beneficial technical and economical effects by allowing the production of activated carbon from tobacco that is easily accessible, common and inexpensive substrate, allowing at the same time the use of wastes from tobacco plants, i.e. leaves' stems, and the second and third tier quality leaves. The proposed method is simple and energy-efficient, because the carbonization process is carried out with simultaneous self-activation, based on the natural presence of compounds that promote the activation of the substrate structure at the molecular level.

The activated carbon obtained in the claimed process has a high thermal and electrochemical stability and thus has a wide range of applications.

The activated carbon obtained by the process according to the invention has high porosity and large specific surface area. The activated carbon produced at temperatures of 600-700° C. is characterized by a texture containing almost exclusively ultramicropores i.e. pores with a diameter less than 0.7-0.8 nm, which can be used as molecular sieves for the separation of various gases such as nitrogen, oxygen, the adsorption of methane, hydrogen, etc., whereas the activated carbon produced at higher temperatures of 800-1000° C. is characterized by the presence of micropores having a diameter of 0.8-1.2 nm, and a small amount of mesopores, i.e. pores having a diameter of from 2 to 50 nm. Such carbon is optimal for being used in electrochemical capacitors.

The use of the activated carbon according to the invention also includes the separation of industrial chemicals and solvents. In addition, in pharmaceutical and food industry it is applicable to the purification of liquids with different kinds of contaminants and harmful compounds.

Activated carbon having a high purity can be used in medicine and catalysis, and activated carbon of lower purity in the purification of air and waste water.

The activated carbon can be applied also as a support for catalysts or as a standalone active catalyst.

The activated carbon obtained according to the invention may also provide an electrode material for electrochemical capacitors used in stationary or mobile systems, and where there is a need for high energy and power density.

The electrode made of activated carbon as described above from the tobacco leaf, used in electrochemical capacitors, allows beneficial technical and economic effects to be obtained, and in particular a significant increase in capacitance. The proper selection of the process parameters allows a product of proper pore texture and surface functionality, appropriately optimized for a specific application in electrochemical capacitors, to be produced. The activated carbon obtained from tobacco leaves in the claimed process, used in the electrodes of electrochemical capacitors, has a high capacitance and very good charge propagation in all electrolytes, i.e. organic, acidic, basic, neutral and ionic liquids. The claimed method of producing the activated carbon is at the same time cost effective, because of its simplicity and low energy requirements.

The electrochemical capacitors manufactured on the basis of tobacco leaves' active carbon obtained according to the invention can be used together with an electrical accumulator; they fill the gap of instantaneous demand of energy needed for proper functioning of the device, for example with the increased energy consumption during acceleration of electric vehicles. They can be used for energy storage and recovery in cars, buses, rail vehicles, emergency doors and evacuation slides in airplanes, UPS, transformer stations, cranes, elevators, wind farms and solar farms etc.

### BRIEF DESCRIPTION OF DRAWINGS

The present invention in the preferred embodiments is shown in the drawings in which:

FIG. 1 shows the pore size distribution (PSD), using the 2D-NLDFT method, of the activated carbons obtained in Examples 1-5 from Burley tobacco stem, with variable temperatures of carbonization.

FIG. 2 shows the BET specific surface area and average pore size (L₀) vs. carbonization temperature of the Burley carbons obtained in Examples 1-5.

FIG. 3 shows the pore size distribution (PSD), using the 2D-NLDFT method, of the activated carbons obtained in Examples 6-10.

FIG. 4 illustrates the capacitance values per gram of activated carbon in one electrode vs. carbonization temperature obtained by galvanostatic (0.2 A·g⁻¹) charge/discharge in 1 mol·L⁻¹ Li₂SO₄ (up to 1.6 V), 1 mol·L⁻¹ TEABF₄ in acetonitrile (up to 2.3 V) and 1 mol·L⁻¹ H₂SO₄ (up to 0.8V) electrolytes, for two-electrode supercapacitors obtained in Examples 11-25, with electrodes made of a range of Burley carbons from 600 to 1000° C.

FIG. 5 illustrates the capacitance values per gram of activated carbon in one electrode obtained by galvanostatic (0.2 A·g⁻¹) charge/discharge in 1 mol·L⁻¹ of Li₂SO₄ (up to various voltage limits), for two-electrode supercapacitors obtained in Examples 11, 14, 17, 20, 23, with electrodes made of a range of Burley carbons.

FIG. 6 shows the cyclic voltammograms using supercapacitors of Examples 21, 26 and 27, constructed with electrodes containing activated carbon of the present invention, as a function of the electrolyte used.

### BEST MODE FOR CARRYING OUT THE INVENTION

The invention is illustrated by the following examples:

### Example 1

### Producing Activated Carbon from Tobacco Burley Leaves' Stems at a Pyrolysis Temperature of 600° C.

Tobacco leaves' stems were dried for 12 hours at 110° C. until reaching a constant weight. The dry mass was grinded to obtain a uniform powder. The powder in the amount of 4 g was placed in a crucible in a tubular furnace under a nitrogen flow rate of 100 ml min⁻¹. The temperature was increased at 10° C. min⁻¹ and the final pyrolysis temperature was set to 600° C. and hold for one hour. The as-prepared carbon was washed successively with an excess of 40% hydrofluoric acid solution, then with distilled water to remove acid and then an excess of 20% hydrochloric acid solution and further with distilled water until the pH of the filtrate was close to 7. The sample was dried in air at the temperature of 110 (±5° C. and then in a stove under reduced pressure for 12 hours at 110 (±5° C. until complete evaporation of water. The obtained product was a black powder.

The porous texture of the product was determined by nitrogen adsorption at −196° C. The pore size distribution was calculated using the 2D-NLDFT theory, described in Jagiello J, Olivier J P, “2D-NLDFT adsorption models for carbon slit-shaped pores with surface energetical heterogeneity and geometrical corrugation”, Carbon 55 (2013) 70-80.

The average pore size (L₀) was calculated from the Dubinin-Radushkevich equation.

The surface functionality of the activated carbon was investigated by thermoprogrammed desorption (TPD), coupling thermogravimetric analysis (TGA) with mass spectrometry (MS) analysis of the evolved gases. The total weight loss at 950° C., the amount of gases evolved as CO₂, CO, H₂O and the total oxygen evolved were calculated from the TPD analysis.

The weight percent of the C, H, N, O elements was determined by elemental analysis.

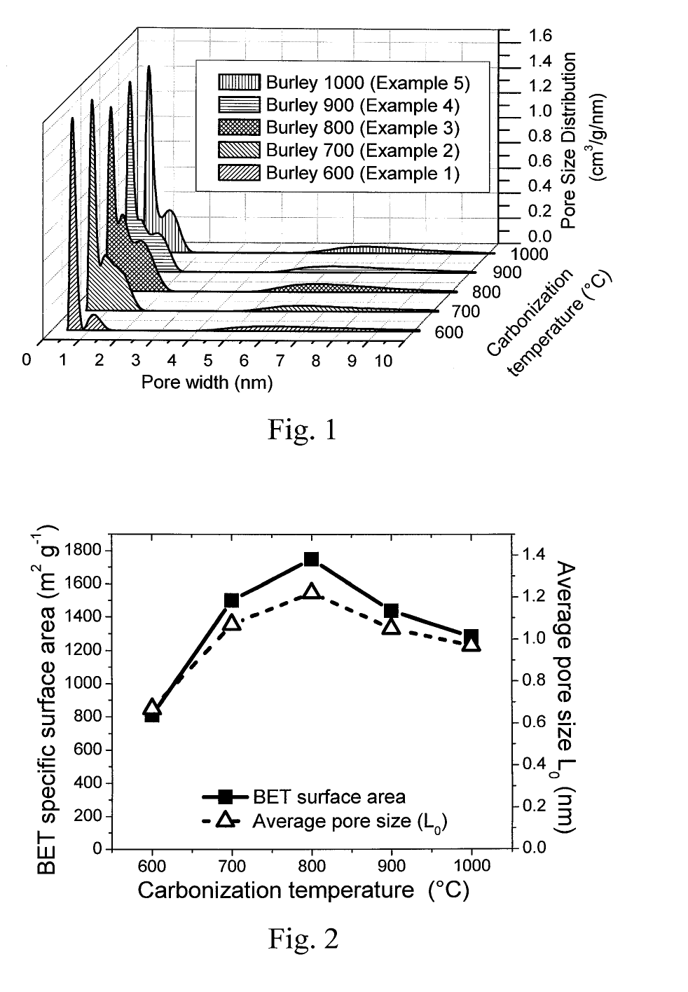

The results of the various analyses are shown in Table 1, FIG. 1 and FIG. 2.

### Example 2

A method for producing activated carbon from tobacco Burley leaves' stems at a pyrolysis temperature of 700° C. Apart of the carbonization temperature, all the other conditions were the same as indicated in Example 1.

The results of the various analyses are shown in Table 1, FIG. 1 and FIG. 2.

### Example 3

A method for producing activated carbon from tobacco Burley leaves' stems at a pyrolysis temperature of 800° C. Apart of the carbonization temperature, all the other conditions were the same as indicated in Example 1.

The results of the various analyses are shown in Table 1, FIG. 1 and FIG. 2.

### Example 4

A method for producing activated carbon from tobacco Burley leaves' stems at a pyrolysis temperature of 900° C. Apart of the carbonization temperature, all the other conditions were the same as indicated in Example 1.

The results of the various analyses are shown in Table 1, FIG. 1 and FIG. 2.

### Example 5

A method for producing activated carbon from tobacco Burley leaves' stems at a pyrolysis temperature of 1000° C. Apart of the carbonization temperature, all the other conditions were the same as indicated in Example 1.

The results of the various analyses are shown in Table 1, FIG. 1 and FIG. 2.

### Example 6

A method for producing activated carbon from tobacco Burley leaves' stems at a pyrolysis temperature of 900° C. for three hours. Apart of the carbonization temperature and time, all the other conditions were the same as indicated in Example 1.

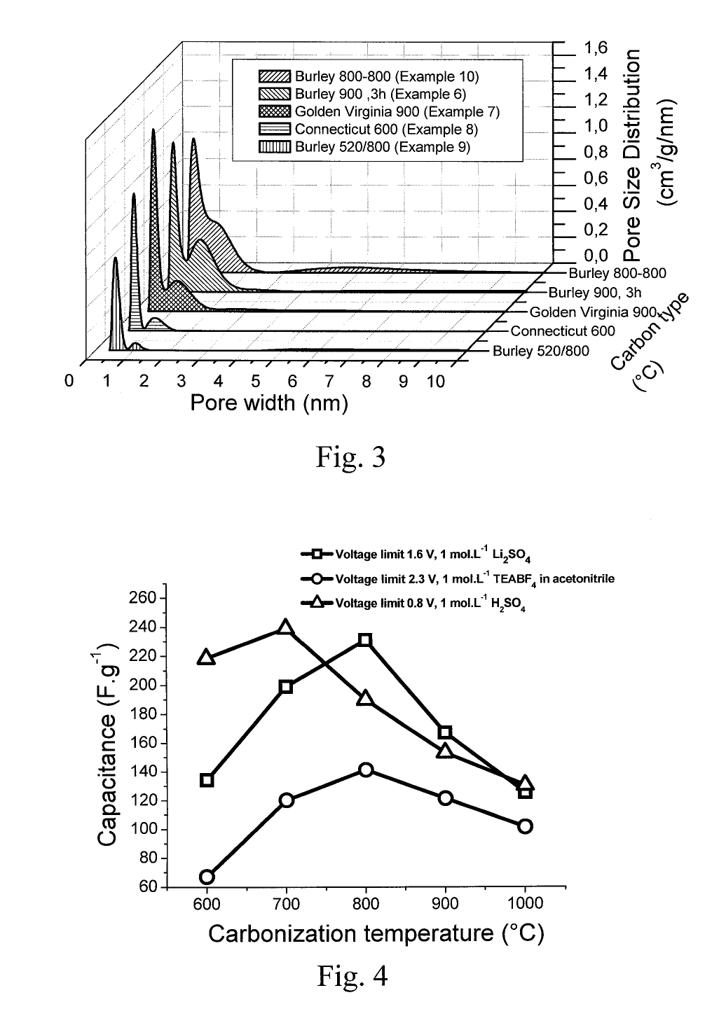

The results of the various analyses are shown in Table 1 and FIG. 3.

### Example 7

A method for producing activated carbon from tobacco Golden Virginia leaves' stems at a pyrolysis temperature of 900° C. Apart of the precursor, all the other conditions are the same as indicated in Example 4.

The results of the various analyses are shown in Table 1 and FIG. 3.

### Example 8

A method for producing activated carbon from tobacco Connecticut leaves (stems and blades) at a pyrolysis temperature of 600° C. Apart of the precursor, all the other conditions were the same as indicated in Example 1.

The results of the various analyses are shown in Table 1 and FIG. 3.

### Example 9

A method for producing activated carbon from tobacco Burley leaves' stems in two high temperature steps at 520° C. and 800° C. (Burley 520/800).

Tobacco leaves' stems were dried for 12 hours at 110° C. until reaching a constant weight. The dry mass was grinded to obtain a uniform powder. The prepared sample in an amount of 60 g was placed in a muffle furnace under a nitrogen flow rate of 20 L·h⁻¹. The temperature was increased at 5° C. min⁻¹ to reach the temperature of 520° C. and hold for two hours. The thus prepared material was further carbonized in a tubular furnace under nitrogen flow rate of 30 L·H⁻¹. The temperature was increased at 5° C. min⁻¹, and the final temperature was set to 800° C. for one hour. The as-prepared carbon was washed successively with an excess of 40% hydrofluoric acid solution, then with distilled water to remove acid and then an excess of 20% hydrochloric acid solution and further with distilled water until the pH of the filtrate was close to 7. The sample was dried in air at a temperature of 110 (±5° C. and then in a stove under reduced pressure at 110 (±5° C. until complete evaporation of water.

The results of the undertaken analyses are shown in Table 1 and FIG. 3.

### Example 10

### Producing Activated Carbon from Tobacco Burley at a Temperature of 800° C. With Post-Treatment at a Temperature of 800° C. After Acids Leaching (Burley 800-800)

All the conditions of manufacturing were the same as indicated in Example 3. The product prepared as indicated in Example 3 was further placed in a tubular furnace under a nitrogen flow of 100 ml min⁻¹. The temperature was increased at 10° C. min⁻¹ and the final pyrolysis temperature was set to 800° C. and hold for one hour. After post-treatment, the sample was ready for further analyses or applications.

The results of the undertaken analyses are shown in Table 1 and FIG. 3.

The mass percentages of groups I and II elements in leaves' stems and blades, and at the various stages of activated carbon manufacturing, are shown in Table 2.

Table 1 shows the parameters of activated carbons manufacturing, the results obtained from: nitrogen adsorption at 77K, thermogravimetric analysis coupled with mass spectrometry (TG+MS) and elemental analysis.

| Parameters of activated carbons | | | | | | | | | |
|---|---|---|---|---|---|---|---|---|---|
| manufacturing | | | | | Nitrogen adsorption at 77 K | | | | |
| | | | Pyrolysis | Pyrolysis | | | V_{micro} | Vₘₑₛₒ | |
| Example | Kind of | Part | temperature | time | S_{BET} | Vₜₒₜₐₗ | <2 nm | 2-50 nm | L₀ (average |
| Number | tobacco | of plant | ° C. | h | m²g⁻¹ | cm³g⁻¹ | cm³g⁻¹ | cm³g⁻¹ | pore size) nm |
| Ex. 1 | Burley | stems | 600 | 1 | 810 | 0.537 | 0.423 | 0.114 | 0.670 |
| Ex. 2 | Burley | stems | 700 | 1 | 1500 | 0.867 | 0.671 | 0.137 | 1.074 |
| Ex. 3 | Burley | stems | 800 | 1 | 1749 | 1.057 | 0.787 | 0.193 | 1.217 |
| Ex. 4 | Burley | stems | 900 | 1 | 1437 | 0.857 | 0.708 | 0.149 | 1.050 |
| Ex. 5 | Burley | stems | 1000 | 1 | 1281 | 0.762 | 0.576 | 0.123 | 0.966 |
| Ex. 6 | Burley | stems | 900 | 3 | 1504 | 0.971 | 0.669 | 0.212 | 1.084 |
| Ex. 7 | Golden | stems | 900 | 1 | 1137 | 0.580 | 0.445 | 0.135 | 0.80 |
| | Virginia | | | | | | | | |
| Ex. 8 | Connecticut | stems & | 600 | 1 | 609 | 0.279 | 0.241 | 0.038 | 0.58 |
| | | blades | | | | | | | |
| Ex. 9 | Burley | stems | 520/800 | 1 | 946 | 0.574 | 0.430 | 0.091 | 0.62 |
| Ex. 10 | Burley | stems | 800-800 | 1 | 1651 | 0.926 | 0.731 | 0.166 | 1.268 |

| | | | | | Thermogravimetric analysis coupled | | | | |
|---|---|---|---|---|---|---|---|---|---|
| Parameters of activated carbons | | | | | with mass spectrometry (TG + MS) | | | | |
| manufacturing | | | | | Weight | | | | |
| | | | Pyrolysis | Pyrolysis | loss | CO₂ | CO | H₂O | O |
| Example | Kind of | Part | temperature | time | 950° C. | 950° C. | 950° C. | 950° C. | 950° C. |
| Number | tobacco | of plant | ° C. | h | wt % | μmol · g⁻¹ | μmol · g⁻¹ | μmol · g⁻¹ | wt % |
| Ex. 1 | Burley | stems | 600 | 1 | 16.8 | 1482 | 3968 | 527 | 12 |
| Ex. 2 | Burley | stems | 700 | 1 | 15.8 | 715 | 605 | 427 | 3.9 |
| Ex. 3 | Burley | stems | 800 | 1 | 10.9 | 440 | 598 | 416 | 3 |
| Ex. 4 | Burley | stems | 900 | 1 | 10.6 | 1795 | 785 | 1139 | 8.8 |
| Ex. 5 | Burley | stems | 1000 | 1 | 7.3 | 608 | 667 | 298 | 3.5 |
| Ex. 6 | Burley | stems | 900 | 3 | 7.8 | 499 | 775 | 578 | 3.8 |
| Ex. 7 | Golden | stems | 900 | 1 | 9.2 | 647 | 1028 | 534 | 4.6 |
| | Virginia | | | | | | | | |
| Ex. 8 | Connecticut | stems & | 600 | 1 | 21.0 | 1042 | 2719 | 1152 | 9.5 |
| | | blades | | | | | | | |
| Ex. 9 | Burley | stems | 520/800 | 1 | 13.5 | 1323 | 1413 | 762 | 7.7 |
| Ex. 10 | Burley | stems | 800-800 | 1 | 7.1 | 732 | 1133 | 223 | 4.5 |

| Parameters of activated carbons | | | | | | | |
|---|---|---|---|---|---|---|---|
| manufacturing | | | | | | | |
| | | | Pyrolysis | Pyrolysis | Elemental analysis | | |
| Example | Kind of | Part | temperature | time | O | N | C |
| Number | tobacco | of plant | ° C. | h | wt % | wt % | wt % |
| Ex. 1 | Burley | stems | 600 | 1 | 15.9 | 3.39 | 73.67 |
| Ex. 2 | Burley | stems | 700 | 1 | 7.99 | 3.4 | 81.76 |
| Ex. 3 | Burley | stems | 800 | 1 | 6.89 | 2.95 | 81.11 |
| Ex. 4 | Burley | stems | 900 | 1 | 4.96 | 2.01 | 84.57 |
| Ex. 5 | Burley | stems | 1000 | 1 | 4.08 | 0.81 | 89.72 |
| Ex. 6 | Burley | stems | 900 | 3 | 3.92 | 1.18 | 90.32 |
| Ex. 7 | Golden | stems | 900 | 1 | 5.6 | 1.64 | 82.46 |
| | Virginia | | | | | | |
| Ex. 8 | Connecticut | stems & | 600 | 1 | 17.7 | 5.35 | 69.04 |
| | | blades | | | | | |
| Ex. 9 | Burley | stems | 520/800 | 1 | | | |
| Ex. 10 | Burley | stems | 800-800 | 1 | 1.94 | 2.33 | 91.95 |

Table 2 shows the mass percent of groups I and II elements in the tobacco Burley precursor and at the various stages of activated carbon manufacturing.

| | Carbon sample | | | | | | |
|---|---|---|---|---|---|---|---|
| | | | | | | | (g) |
| | | | | | | | Burley 800 |
| | | | | (d) | (e) | (f) | after washing |
| | | | (c) | Burley 800 | Burley 800 | Burley 800 | with HF |
| | (a) | (b) | Burley | after | after | after | and HCl |
| | Burley - | Burley - | 800 | washing | washing | washing | post- |
| | leaf's | leaf's | without | with HF | with HF | with HCl | treated at |
| | stems | blades | washing | and HCl | solely | solely | 800° C. |
| Element | % | % | % | % | % | % | % |
| Ca | 3.97 | 5.48 | 10.01 | 0.0472 | 17.1 | 0.107 | 0.0452 |
| K | 7.16 | 3.17 | 18.4 | 0.0211 | 0.307 | 0.048 | 0.02287 |
| Mg | 0.493 | 0.58 | 0.85 | 0.0053 | 1.107 | 0.04613 | 0.00537 |
| Na | 0.0058 | 0.0053 | 0.13 | 0.0049 | 0.02 | 0.00137 | 0.0062 |

All carbons (c-g) are derived from leaf's stem precursor (a). The percentages are related to the mass of samples. The precursor (b) and carbons (e-f) are introduced for comparing the elemental composition of blades and stems, and the methodology of carbons cleaning, respectively. These examples prove that the use of leaves' stems along with HF and HCl successively, to remove the groups I and II elements, provides the required purity of activated carbon for supercapacitors.

### Example 11

Manufacturing of electrochemical capacitor with aqueous lithium sulfate electrolyte and with electrodes based on activated carbon from tobacco Burley carbonized at a temperature of 600° C.

The electrochemical capacitor electrodes are made of a composite consisting of 85% proportion by weight of activated carbon formed from tobacco Burley 600° C., described in Example 1, 10% by weight of polyvinylidene fluoride and 5 wt % of carbon black that possesses a good electrical conductivity.

The electrodes were made in the form of pellets with a diameter of 10 mm and a weight of ca. 10 mg and a thickness of ca. 0.3 mm by pressing with a hydraulic press. Thus as-prepared two identical electrodes were separated with a glass fiber separator, and placed between two current collectors in a closed vessel filled with 1 mol L⁻¹ lithium sulfate. The capacitor was charged/discharged at constant current up to 1.6 V, and a high capacitance of 134 F g⁻¹ was determined from galvanostatic discharge. All along the examples 11 to 27, the capacitance values are expressed in farads per gram of activated carbon in one electrode (F·g⁻¹).

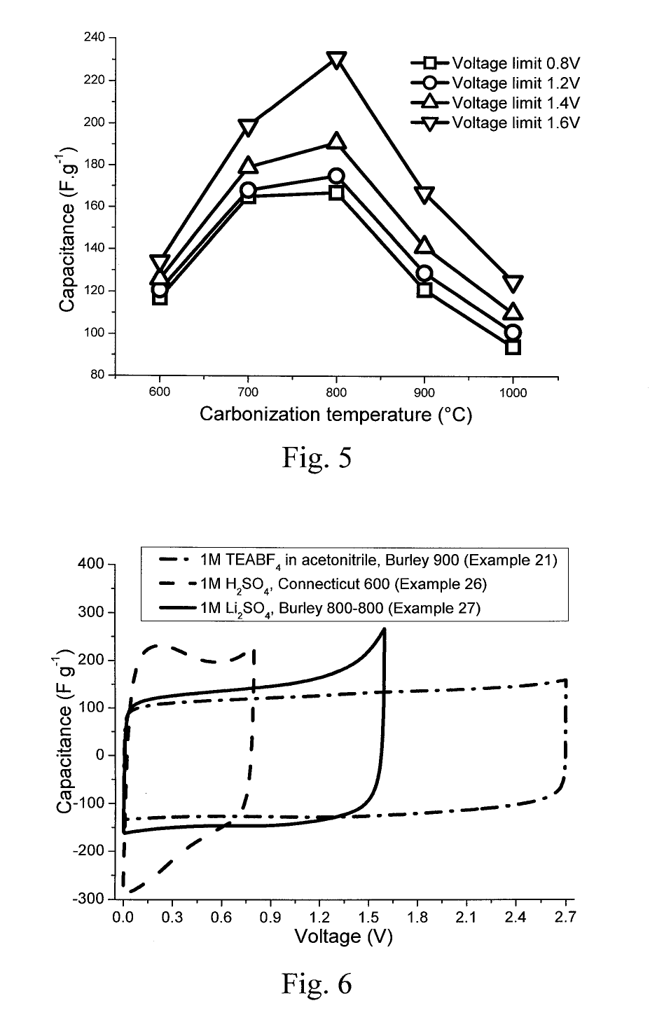

The results from galvanostatic charge/discharge are shown and compared with other examples in FIG. 4 and in FIG. 5.

### Examples 12-27

Electrochemical capacitor with different electrolytes and with electrodes based on activated carbon from tobacco Burley or tobacco Connecticut carbonized at various temperatures.

In the following examples, all the manufacturing conditions of carbons were the same as indicated in Example 1. The only parameter that varied was the pyrolysis temperature. Moreover, the capacitors were assembled in accordance with Example 11, with different carbon as the electrode material, and with three different electrolytes, specified for each example. In case of the TEABF₄ in acetonitrile electrolyte, the assembling was realized inside a glove box under argon atmosphere. Table 3 presents the variable data for each specific example of supercapacitor:

TABLE 3
Variable data for examples 11-27

| | Carbon type used in | | Electrolyte used in |
|---|---|---|---|
| Example | electrochemical | Pyrolysis | electrochemical |
| No | capacitor | temperature | capacitor |
| 11 | Burley of Example 1 | 600 | 1 mol · L⁻¹ Li₂SO₄ |
| 12 | Burley of Example 1 | 600 | 1 mol · L⁻¹ TEABF₄ |
| | | | in acetonitrile |
| 13 | Burley of Example 1 | 600 | 1 mol · L⁻¹ H₂SO₄ |
| 14 | Burley of Example 2 | 700 | 1 mol · L⁻¹ Li₂SO₄ |
| 15 | Burley of Example 2 | 700 | 1 mol · L⁻¹ TEABF₄ |
| | | | in acetonitrile |
| 16 | Burley of Example 2 | 700 | 1 mol · L⁻¹ H₂SO₄ |
| 17 | Burley of Example 3 | 800 | 1 mol · L⁻¹ Li₂SO₄ |
| 18 | Burley of Example 3 | 800 | 1 mol · L⁻¹ TEABF₄ |
| | | | in acetonitrile |
| 19 | Burley of Example 3 | 800 | 1 mol · L⁻¹ H₂SO₄ |
| 20 | Burley of Example 4 | 900 | 1 mol · L⁻¹ Li₂SO₄ |
| 21 | Burley of Example 4 | 900 | 1 mol · L⁻¹ TEABF₄ |
| | | | in acetonitrile |
| 22 | Burley of Example 4 | 900 | 1 mol · L⁻¹ H₂SO₄ |
| 23 | Burley of Example 5 | 1000 | 1 mol · L⁻¹ Li₂SO₄ |
| 24 | Burley of Example 5 | 1000 | 1 mol · L⁻¹ TEABF₄ |
| | | | in acetonitrile |
| 25 | Burley of Example 5 | 1000 | 1 mol · L⁻¹ H₂SO₄ |
| 26 | Connecticut of | 600 | 1 mol · L⁻¹ H₂SO₄ |
| | Example 8 | | |
| 27 | Burley of Example 10 | 800-800 | 1 mol · L⁻¹ Li₂SO₄ |

The results of capacitance for Examples from 11 to 25 are presented in FIG. 4.

The results of capacitance for Examples 11, 14, 17, 20 and 23 are presented in FIG. 5.

The cyclic voltammetry curves of Examples 21, 26 and 27 are presented in FIG. 6.

1. A method for producing activated carbon from tobacco, characterized in that the tobacco plant is dried to completely evaporate water, and the resultant dry mass is subjected to simultaneous carbonization and self-activation by heating at a temperature of 550-1000° C., preferably 750-850° C., under anaerobic conditions in an atmosphere of an inert gas, and the inorganic residue present in the resulting carbon is dissolved, and the carbon is further washed with water until the filtrate reaches a constant pH close to 7, and then dried to completely evaporate the water.

2. A method according to claim 1, characterized in that the tobacco plant is dried to completely evaporate the water at a temperature in the range 80-200° C., preferably 105-115° C., the resultant dry mass is preferably grinded to a uniform powder, and then the process of simultaneous carbonization and self-activation is carried out preferably with a flow of nitrogen as the inert gas, for at least 15 min, preferably at least 60 min, after which the inorganic residue present in the resulting carbon is dissolved by an inorganic base followed by an inorganic acid or preferably is dissolved by at least one inorganic acid.

3. A method according to claim 2, wherein the inorganic residue present in the resulting carbon is dissolved by sodium hydroxide followed by hydrochloric acid or preferably is dissolved by hydrofluoric acid and/or hydrochloric acid.

4. A method according to claim 1, characterized in that the tobacco dry mass, before simultaneous carbonization and self-activation, is pre-treated by heating at a temperature of 400-520° C. in an inert atmosphere, to evaporate the oily fraction.

5. A method according to claim 4, characterized in that the resultant activated carbon is further subjected to a thermal post-treatment at a temperature of 700-1000° C., preferably 800-900° C. for at least 15 minutes.

6. A method according to claim 1, characterized in that the tobacco plant material subjected to the process of simultaneous carbonization and self-activation is tobacco leaf blade and/or tobacco leaf stem, preferably tobacco leaf stem.

7. Activated carbon produced by simultaneous carbonization and self-activation of tobacco leaves as described in claim 1, characterized in that it has a specific surface area from 600 to 2000 m² g⁻¹, preferably 1700 m² g⁻¹ and has an extensive amount of ultramicropores and mesopores, wherein the ratio of micropore volume to the mesopore volume is at least 3:1, up to 10:1, preferably 4:1, the average pore size (L₀) is in the range of 0.55-1.3 nm, preferably 0.8-1.2 nm, and the total pore volume in the range of 0.2 to 1.25 cm³ g⁻¹.

8. Use of activated carbon of claim 7 for gas molecular separation, pollutant sorption, sorption of chemicals, for hydrogen and methane storage, as a carrier for catalysts and as a standalone catalyst, for the purification of gases, air, water and solvents, or as an electrode material.

9. Carbon electrode made of a composite having as the main component the activated carbon of claim 7.

10. Carbon electrode according to claim 9 made of a composite comprising at least 65% by weight, preferably 85% by weight of the activated carbon having a specific surface area from 600 to 2000 m² g⁻¹, preferably 1700 m² g⁻¹, wherein the average pore size (L₀) is in the range of 0.5-1.3 nm, preferably 0.8-1.2 nm, and the total pore volume in the range from 0.2 to 1.25 cm³ g⁻¹, wherein the ratio of the micropore volume to the mesopore volume is at least 3:1, up to 10:1, preferably 4:1, mixed with a polymeric binder in an amount up to 25% by weight, preferably 5 to 10% by weight relative to the weight of the electrode.

11. Carbon electrode according to claim 9 or 10, wherein the composite comprises additionally carbon black or graphene or carbon nanotubes in the amount of up to 10% by weight of the electrode, preferably 5% by weight.

12. Carbon electrode according to claim 11, wherein the polymeric binder can be selected from polyvinylidene fluoride, polytetrafluoroethylene, carboxymethyl cellulose, sodium alginate, cellulose.

13. An electrochemical capacitor according to claim 7, comprising at least one electrode made of activated carbon, separated from the other electrode with a porous separator, located in a chamber filled with an electrolyte, characterized in that the electrode is made of a composite having as a main component the activated carbon.

14. The capacitor according to claim 13, wherein the electrode is made of 65% by weight, preferably 85% by weight of the activated carbon, mixed with a polymeric binder in the amount of up to 25%, preferably 5 to 10% by weight relative to the weight of the electrode.
